(19) United States
(12) Patent Application Publication
(10) Pub. No.: US 2002/0093526 A1
(43) Pub. Date: Jul. 18, 2002

(54) Method of and system for providing information, and computer product

(76) Inventor: Shigehisa Tonomura, Kawasaki (JP)

Correspondence Address: STAAS & HALSEY LLP, 700 11TH STREET, NW, SUITE 500, WASHINGTON, DC, 20001, US

(21) Appl. No.: 09/879,160

(22) Filed: Jun. 13, 2001

(30) Foreign Application Priority Data
Jan. 17, 2001 (JP) 2001-008776

(51) Int. Cl. G06F 3/00; G06F 13/00

(52) U.S. Cl. 345/723

(57) ABSTRACT

Photographed data including photographing position information are accepted from a user and contents corresponding to the photographing position information from a position-distinction contents database based on the photographing position information in the accepted photographed data. The position-distinction contents database stores photographing position information and contents in a correlated manner. Finally, the acquired contents are inserted into a portion of the photographed data corresponding to the photographing position information.

### FIELD OF THE INVENTION

This invention relates to a technology for editing, providing and receiving image data.

### BACKGROUND OF THE INVENTION

Conventionally, a user who captures images or movies (“photographed data”) using home videos, digital cameras etc. generally edits the photographed data as hobby. The editing here means, for example, inputting characters, providing display effects in the images or movies, or changing the order of the images. Such editing is performed using, for example, personal computers, or dedicated instruments.

Assume that the user goes to an amusement park. In the amusement park, there are famous attractions, symbolic buildings, landscapes, character dolls, sounds that represent the amusement park. Similar is the case with other visitor's spots or historic places.

When taking a photograph on such famous places, generally the user wants to include the surrounding for his memories, and based on that he decides the location of the photo. However, the famous places are generally crowded so that unwanted people come in the background of the photograph. Sometimes the weather is bad. As a result, there are cases that the user cannot capture what he desires.

Thus, photographing at such places is troublesome and time taking task and, therefore, the user can capture only a few good photographs. Since there are only a few good photographs, there is a drawback that the objects for editing are also limited.

### SUMMARY OF THE INVENTION

It is an object of the present invention to provide a technology of inserting suitable contents into photographed data of users and editing the photographed data.

According to one aspect of the present invention, photographed data including photographing position information are accepted from a user and contents corresponding to the photographing position information from a position-distinction contents database based on the photographing position information in the accepted photographed data. The position-distinction contents database stores photographing position information and contents in a correlated manner. Finally the acquired contents are inserted into a portion of the photographed data corresponding to the photographing position information.

Thus, contents that depend on the photographing position can be inserted and edited into the photographed data efficiently. Therefore, even if the user misses the chance to photograph symbols or the like peculiar to the photographing place, photographed data, into which the symbols or the like are inserted and edited, can be provided.

According to another aspect of the present invention, photographed data including photographing position information is transmitted to a server, and the photographed data into which contents corresponding to the photographing position information are inserted and edited by the server is received from the server based on the transmitted photographing position information.

Thus, the user transmits photographed data to the server and can acquire the photographed data into which contents according to the photographing position are inserted and edited. Therefore, even if the user misses the chance to photograph symbols or the like peculiar to the photographing position, the user can acquire the photographed data into which the symbols or the like are inserted and edited easily.

The computer readable recording medium according to another aspect of the present invention stores a computer program which when executed realizes the method according to the present invention.

Other objects and features of this invention will become apparent from the following description with reference to the accompanying drawings.

### BRIEF DESCRIPTION OF THE DRAWINGS

FIG. 1 shows a configuration of the system according to an embodiment of the present invention;

FIG. 2 shows an example of contents of the position-distinction contents DB shown in FIG. 1;

FIG. 3 shows an example of photographed data accepted from the users;

FIG. 4 shows an example of edited photographed data to be output to users;

FIG. 5A and FIG. 5B are examples showing contents insertion and editing for photographed data; and

FIG. 6 is a flowchart of method according to the present invention.

### DESCRIPTION OF THE PREFERRED EMBODIMENTS

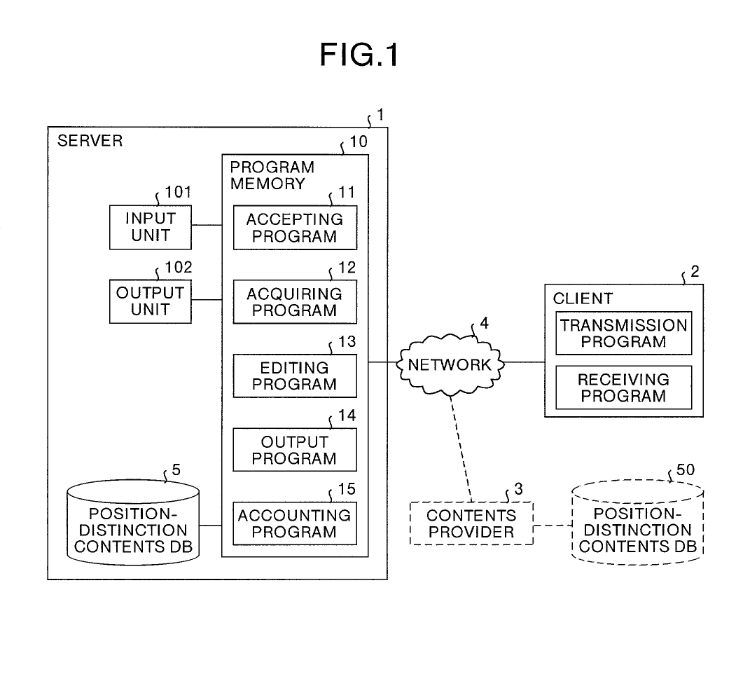

Preferred embodiments of the present invention will be explained below with reference to accompanying drawings. FIG. 1 shows a configuration of the system according to an embodiment of the present invention. This system includes the server 1 and client 2 that are connected to each other through the network 4.

The server 1 is provided with the program memory 10, position-distinction contents database 5, input unit 101, and output unit 102. The program memory 10 stores the accepting program 11, acquiring program 12, editing program 13, output program 14, and accounting program 15.

The user operates the client 2. The client 2 is provided with the transmission program 21 and receiving program 22.

The accepting program 11 of the server 1 accepts photographed data including photographing position information and information for specifying a user. This information may be transmitted by the transmission program 21 of the client 2 via the network 4, or may be directly input using the input unit 101.

The acquiring program 12 refers to the position-distinction contents database 5 based on photographing position information included in the photographed data accepted by the accepting program 11 and acquires position-distinction contents corresponding to the photographing position information.

The editing program 13 inserts and edits the position-distinction contents acquired by the acquiring program 12 into a portion of the photographing position information in the photographed data accepted by the accepting program 11.

The output program 14 outputs the photographed data edited by the editing program 13 and contents fee information calculated by the accounting program 15 to the client 2 via the network 4 based on information for specifying a user accepted by the accepting program 11 or by means of the output unit 102.

The accounting program 15 calculates a total amount of pay contents, inserted and edited into the photographed data of a user by the editing program 13, based on information relating to fees of contents acquired from the position-distinction contents database 5 by the acquiring program 12.

The position-distinct contents database 5 manages information of photographing positions and contents corresponding to the information and fees of the contents in a state that they relate to one another.

The transmission program 21 of the client 2 transmits photographed data including photographing position information and information for specifying a user to the server 1 via the network 4. When a user photographs objects by means of a photographing equipment equipped with GPS function and function for obtaining the position information, the user obtains photographed data including information relating to the photographing position and transmits the data to the server 1 by using the transmission program 21.

The receiving program 22 receives edited photographed data transmitted from the server 1 via the network 4 and information about fees of inserted and edited contents transmitted from the server 1 via the network 4.

In addition, the present invention may be constituted so that a contents provider 3 represented by a dotted line, which is connected to the server 1 and the client 2 via the network 4, have position-distinction contents database 50 which is the similar to the position-distinction contents database 5. In this case, the acquiring program 12 acquires position-distinction contents from the position-distinction contents database 50 connected to the contents provider 3 via the network 4.

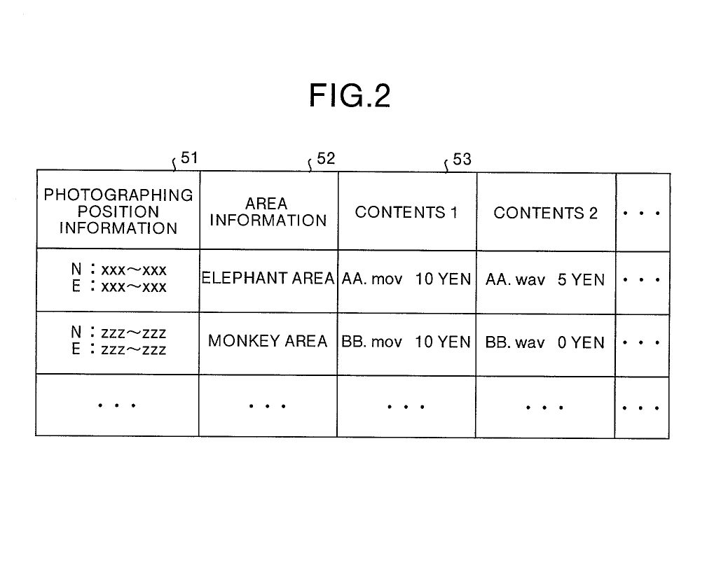

FIG. 2 shown an example of the contents of the position-distinction contents database 5. The position-distinction contents database 5 stores photographing position information 51 for specifying a photographing position, area information 52 for specifying an area of the photographing position, and contents 53. The contents 53 are information about images of characteristic buildings, landscapes and character dolls to be symbols of photographing positions or data of sounds or the like and information about their fees in a state that they relate to one another.

The photographing position information 51 is the information about longitude and latitude of photographing positions, and a photographing position can be identified by this information.

The area information 52 is the information that indicates specific and small areas in a bigger area of the photographing position, and an identification can be made by this information as to which area the photographing position is in. This information may be an area ID for identifying an area.

For example, when a zoo is a photographing area, the area information 52 holds information about areas in the zoo such as the places where elephants are present (“elephant area”), or where monkeys are present (“monkey area”) Therefore, according to the photographing position information 51, a position where an object is photographed can be identified by a pinpoint, and according to the area information 52, an area where the object is photographed can be identified.

The contents 53 hold data of respective contents and their fees, and contents data according to the photographing position can be specified by this information, and a fee according to the contents can be calculated.

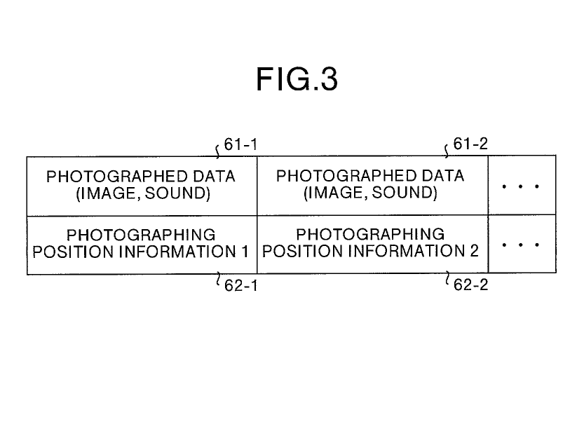

FIG. 3 shows an example of data accepted from a user by the accepting program 11. The photographed data accepted from a user include information 61-1 and 61-2 about photographed image and sound and photographing position information 62-1 and 62-2 for identifying a photographing position. The contents of the photographing position information 62-1 and 62-2 correspond to the photographing position information 51 and the area information 52 of the position-distinction contents database 5, and are both or one of information showing longitude and latitude of a photographing position and information showing an area.

For example, when video data captured by the user when he was moving from an elephant area to a monkey area in a zoo, the photographed data include the photographed data 61-1 photographed in the elephant area, the information 62-1 showing the elephant area, the photographed data 61-2 photographed in the monkey area as a moving destination and the information 62-2 showing the monkey area.

The acquiring program 12 compares the photographing position information 62-1 and 62-2 with the photographing position information 51 or the area information 52 in the position-distinction contents database 5 so as to be capable of acquiring the contents 53 corresponding to the photographing position.

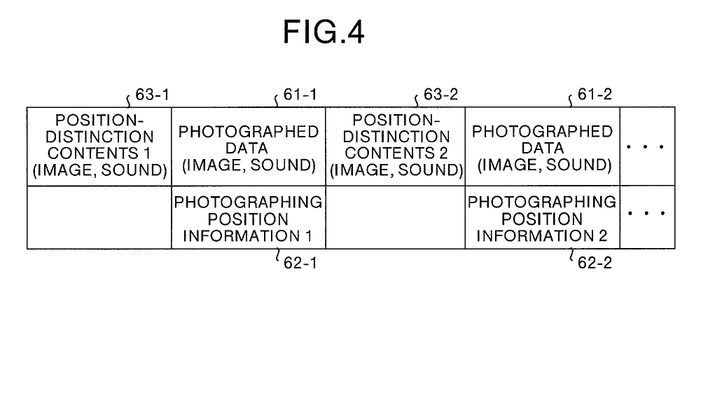

FIG. 4 shows an example of edited photographed data output by the output program 14. The editing program 13 inserts and edits the position-distinction contents 63-1 and 63-2 corresponding to photographing positions acquired by the acquiring program 12 into the photographed data shown in FIG. 3 accepted by the accepting program 11 from a user. As a result, these position-distinction contents are added to the original photographed data 61-1 and 61-2 and the photographing position information 62-1 and 62-2.

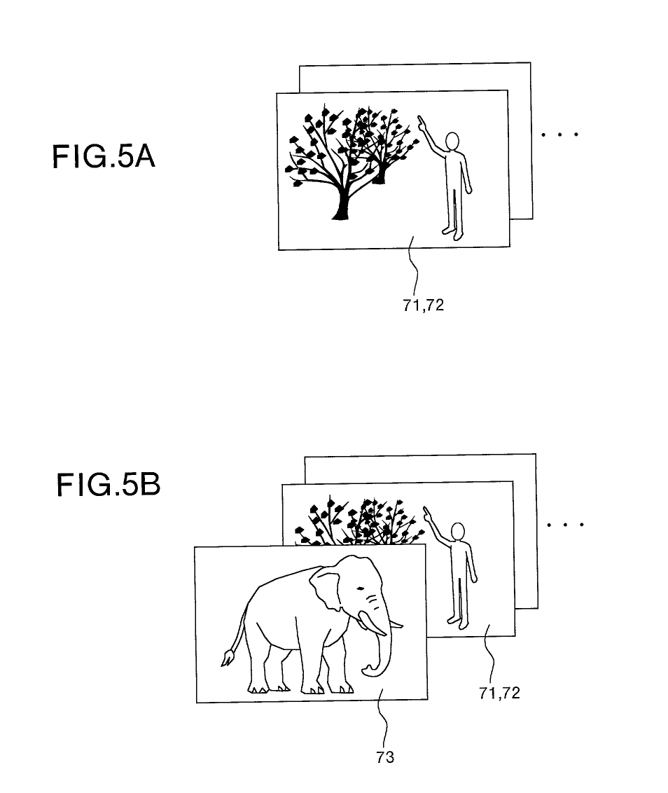

FIG. 5A and FIG. 5B are examples showing contents insertion and editing to the photographed data by means of the editing program 13. FIG. 5A shows the photographed data before editing, i.e. data accepted by the accepting program 11 from a user (see FIG. 3). FIG. 5B shows the photographed data after editing by the output program 14 (see FIG. 4). In these figures, each photograph represents a frame of the original dynamic picture.

For example, assume that the photographed data 71 corresponding to the photographed data 61-1 of FIG. 3 photographed in the elephant area and photographing position information 72 corresponding to the photographing position information 62-1 of FIG. 3 are accepted from a user (see FIG. 3). Then, contents 73 which is an image of an elephant and sound of its cry as contents corresponding to the position-distinction contents 63-1 (see FIG. 4) are inserted and edited into the original photographed (see FIG. 5B). The acquiring program 12 refers to the position-distinction contents database 5 and acquires the contents 73.

The photographed data need not only be the dynamic images. That is, the photographed data may even be digital still images. In that case also, the contents 73 corresponding to photographing position information obtained similarly may be added as new images, or the position-distinction contents 73 may be attached to a position in the photographed image specified by the user.

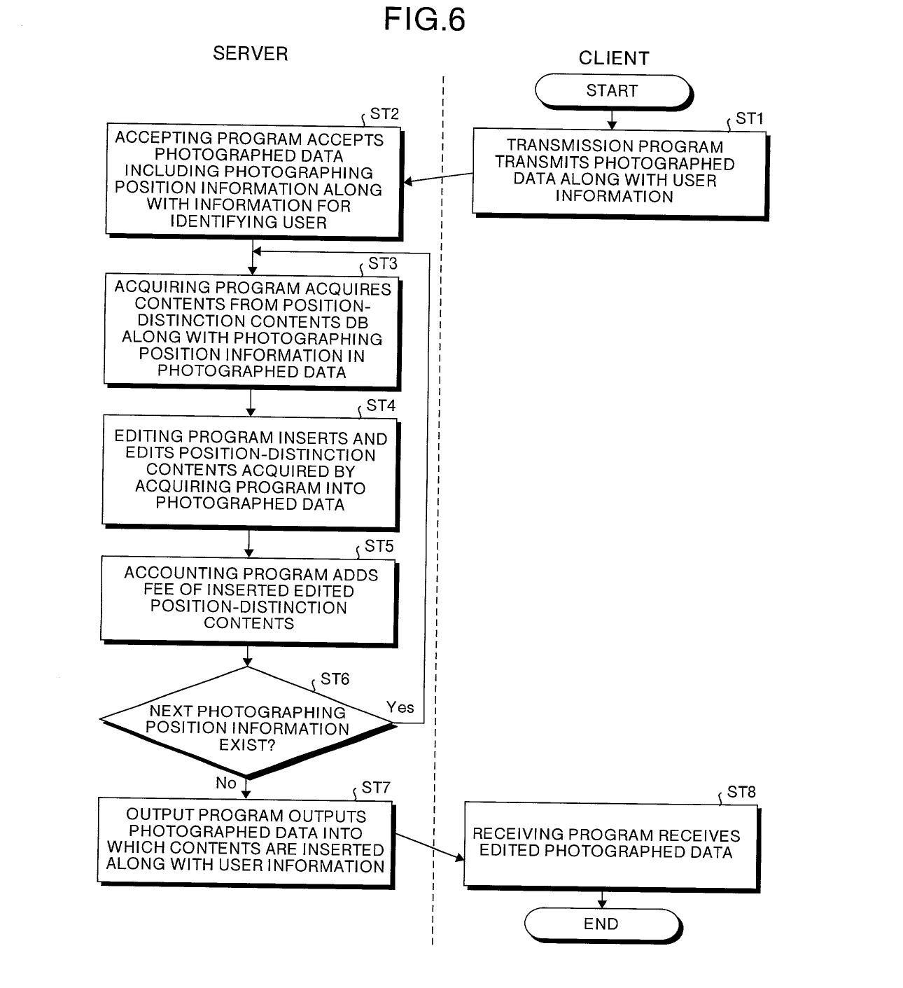

FIG. 6 is a flowchart for explaining the method according to the present invention. At step ST1, the transmission program 21 of the client 2 transmits photographed data including photographing position information and information for specifying a user correspondingly to the photographed data to the server 1 via the network 4.

The photographed data including the photographing position information are, for example, shown in FIG. 3. The information for specifying a user is information such as user's name, cover address, ID number, e-mail address and address of a computer, and may include an identifier for payment. Moreover, data from a user may be input not by the transmission program 21 but by the input unit 101 of the server 1.

At step ST2, the accepting program 11 of the server 1 accepts photographed data including transmitted photographing position information and information for specifying the user. The accepted information is stored in a work area of the server. Such a work area has not been shown in the figures.

At step ST3, the acquiring program 12 refers to the photographing position information included in the photographed data stored by the accepting program 11 one by one. Thereafter, the acquiring program 12 retrieves the photographing position information 51 or the area information 52 of the position-distinction contents database 5 using the referred photographing position information as a key and acquires the corresponding contents 53.

At step ST4, as shown in FIG. 5A and FIG. 5B, the editing program 13 inserts and edits the contents acquired by the acquiring program 12 at ST3 into the photographed data stored by the accepting program 11 at step ST1. The result of edition is stored in the work area in a state that they relate to the information for specifying the user stored by the accepting program 11 at step ST1.

At step ST5, the accounting program 15 refers to the fee of the contents which are inserted and edited into the photographed data of the user by the editing program 13 so as to add and hold the fee.

For example, when the photographing position information 62-1 in the photographed data shown in FIG. 3 is the elephant area, the acquiring program 12 retrieves the area information 52 of the position-distinction contents DB shown in FIG. 2 using the information showing the elephant area in the photographing position information 62-1 as a key, and refers to the corresponding contents 53 so as to acquire a file AA.mov which costs 10 yen and file AA.wav which costs 5 yen corresponding to the elephant area.

As shown in FIG. 4, the editing program 13 inserts and edits the files AA.mov and AA.wav which are data of the contents acquired by the acquiring program 12 as the position-distinction contents 63-1 along with the photographing position information 62-1 in the original photographed data into the photographed data.

Thereafter, the accounting program 15 refers to charges for the uses of AA.mov and AA.wav inserted and edited by the editing program 13 based on the fees of the objective contents acquired by the acquiring program 12, and adds 10 yen for AA.mov and 5 yen for AA.wav, and calculates the total fee at 15 yen and holds it.

Therefore, at steps ST3, ST4, and ST5, the contents corresponding to the photographing position are inserted into the photographed data accepted from the user, and the fee according to the inserted contents is calculated.

At step ST6, the acquiring program 12 refers to whether next photographing position information exits in the photographed data. If the next photographing position information exits, the system control is returned to step ST3, and steps ST3 through ST5 are repeated. If the next photographing position information does not exist, that will mean that all the photographing position have been processed, and the system control is given to step ST7.

At step ST7, the output program 14 refers to the information for specifying the user and the edited photographed data which were stored at step ST4 by the editing program 13, and the fee calculated and held by the accounting program 15, and outputs the photographed data and the information about the fee according to use of the contents to corresponding user via the network 4. In another method, the edited photographed data and the information about a fee may be output from the output unit 102 according to a request of output of the edited photographed data by using the information for specifying the user from the input unit 101 as a key.

At step ST8, the receiving program 22 of the client 2 receives the edited photographed data and the information about a fee output at step ST7 by the output program via the network 4.

Since the information providing method of the present invention is realized on the server 1 as a computer as explained above, contents corresponding to a photographing position are inserted and edited to a photographed data accepted from a user based on photographing position information included in the photographed data, and the edited photographed data can be provided to the user as a client. Moreover, since fees are added according to uses of contents, appropriate fee can be calculated.

In addition, the information receiving method of the present invention is realized on the client 2 as a computer as explained above, a user transmits photographed data including photographing position information and can receive the photographed data into which the contents corresponding to the photographing position information are inserted and edited.

The information providing method is not limited only to the one explained above. For example, as represented by a dotted line in FIG. 1, the contents provider 3 may be provided with the position-distinction contents database 50, and the acquiring program 12 may acquire contents corresponding to a photographing position from the position-distinction contents database 50 of the contents provider 3.

Moreover, if the present invention is applied to data which was photographed by a user visiting a zoo, when the contents provider 3 does not exits, the computer of the user is the client 2, and the service server which intermediates between the user and the zoo is the server 1, and the server 1 may additionally acquire data to be stored in the position-distinction contents database 5 from the zoo. The server 1 may be set as any places, for example, it may be set in the zoo.

If the contents provider 3 exists, the zoo may be the contents provider 3, the user may the client 2, and the service server which intermediates between the user and the zoo may be the server 1.

Further, the transmission program 21 of the client 2 or the input unit 101 of the server 1 is made to specify a type of contents to be inserted and edited, and this instruction is accepted by the accepting program 11, and the editing program selects contents to be inserted according to the specified type of the contents. As a result, only the contents according to desire of the user can be inserted and edited. For example, only image data can be inserted, and only contents relating to a specific symbol can be inserted.

According to the present invention, the server can insert and edit contents according to a photographing position into photographed data accepted from the user efficiently. Therefore, even if the user misses the chance to photograph symbols or the like peculiar to the photographing position, photographed data into which the symbols are inserted and edited can be provided.

Further, since fees are added according to uses of the contents, the contents can be charged appropriately.

In addition, the user can acquire photographed data obtained by inserting contents according to a photographing position are inserted and edited into data photographed by the user. Therefore, it is not necessary to consider about photographing respective symbols at the time of the photographing, and the user can acquire photographed data, which are edited so that the atmosphere of the photographing position can be felt, easily.

A computer program containing instructions which when executed on a computer causes the computer to perform the method according to the present invention is recorded on computer readable-recording medium. This computer readable-recording medium may be a floppy disk or a CD-ROM. Alternately the program may be stored at a server and the program may be downloaded when required. Otherwise, the program may be executed while it is at the server, i.e. without downloading from the server.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information providing method comprising the steps of:
accepting photographed data including photographing position information from a user;
acquiring contents corresponding to the photographing position information from a position-distinction contents database based on the photographing position information in the accepted photographed data, wherein said position-distinction contents database stores photographing position information and contents in a correlated manner; and
inserting and editing the acquired contents into a portion of the photographed data corresponding to the photographing position information.

2. The information providing method according to claim 1 further comprising the step of calculating an appropriate fee for providing the contents.

3. The information providing method according to claim 1, wherein the accepting step further includes the steps of,
accepting information for specifying the user along with the photographed data including the photographing position information; and
transmitting the inserted and edited photographed data to the user based on the accepted information for specifying the user.

4. The information providing method according to claim 1, wherein the photographed data are data photographed in a certain bigger area, and the photographing position information is information about a smaller area in the bigger are where the photographing is executed or information showing a photographing spot.

5. The information providing method according to claim 1, wherein the photographed data are frames of original dynamic images.

6. An information receiving method comprising the steps of:
transmitting photographed data including photographing position information to a server; and
receiving the photographed data, into which contents corresponding to the photographing position information are inserted and edited by the server, from the server based on the transmitted photographing position information.

7. A computer program which when executed on a computer realizes the steps of:
accepting photographed data including photographing position information from a user;
acquiring contents corresponding to the photographing position information from a position-distinction contents database based on the photographing position information in the accepted photographed data, wherein said position-distinction contents database stores photographing position information and contents in a correlated manner; and
inserting and editing the acquired contents into a portion of the photographed data corresponding to the photographing position information.

8. A computer program which when executed on a computer realizes the steps of:
transmitting photographed data including photographing position information to a server; and
receiving the photographed data, into which contents corresponding to the photographing position information are inserted and edited by the server, from the server based on the transmitted photographing position information.

9. An information providing apparatus comprising:
an accepting unit which accepts photographed data including photographing position information from a user;
an acquiring unit which acquires contents corresponding to the photographing position information from a position-distinction contents database based on the photographing position information in the accepted photographed data, wherein said position-distinction contents database stores photographing position information and contents in a correlated manner; and
an editing unit which inserts and edits the acquired contents into a portion of the photographed data corresponding to the photographing position information.

10. An information providing apparatus comprising:
a transmitting unit which transmits photographed data including photographing position information to a server; and
a receiving unit which receives the photographed data, into which contents corresponding to the photographing position information are inserted and edited by the server, from the server based on the transmitted photographing position information.

11. A computer readable medium for storing instructions, which when executed on a computer, causes the computer to perform the steps of:
accepting photographed data including photographing position information from a user;
acquiring contents corresponding to the photographing position information from a position-distinction contents database based on the photographing position information in the accepted photographed data, wherein said position-distinction contents database stores photographing position information and contents in a correlated manner; and
inserting and editing the acquired contents into a portion of the photographed data corresponding to the photographing position information.

12. A computer readable medium for storing instructions, which when executed on a computer, causes the computer to perform the steps of:
transmitting photographed data including photographing position information to a server; and
receiving the photographed data, into which contents corresponding to the photographing position information are inserted and edited by the server, from the server based on the transmitted photographing position information.
